(19) United States
(12) Patent Application Publication
(10) Pub. No.: US 2024/0010112 A1
(43) Pub. Date: Jan. 11, 2024

(54) SYSTEM AND METHOD FOR CONTROLLING TEMPERATURE OF A MOUNTING PORTION

(71) Applicants: HYUNDAI MOTOR COMPANY, Seoul (KR); KIA CORPORATION, Seoul (KR)

(72) Inventor: Sang Shin Lee, Suwon-si (KR)

(73) Assignees: HYUNDAI MOTOR COMPANY, Seoul (KR); KIA CORPORATION, Seoul (KR)

(21) Appl. No.: 18/082,710

(22) Filed: Dec. 16, 2022

(30) Foreign Application Priority Data
Jul. 5, 2022 (KR) 10-2022-0082249

(51) Int. Cl. B60N 2/75; B60N 2/56

(52) U.S. Cl. CPC B60N 2/797; B60N 2/5678

(57) ABSTRACT

A control system of a mounting portion upon which an arm of a passenger rests may include: the mounting portion upon which the arm of the passenger lays down and rests, a temperature adjuster provided to the mounting portion to increase a temperature of a surface of the mounting portion, a body temperature sensor provided to the mounting portion to measure a temperature of the arm of the passenger in contact with the mounting portion, a surface temperature sensor configured to measure the temperature of the surface of the mounting portion, and a controller configured to control an output of the temperature adjuster based on a difference between the temperature of the surface of the mounting portion measured by the surface temperature sensor and the temperature of the arm of the passenger measured by the body temperature sensor.

### CROSS-REFERENCE TO RELATED APPLICATION

This application claims, under 35 U.S.C. § 119(a), the benefit of and priority to Korean Patent Application No. 10-2022-0082249, filed on Jul. 5, 2022, the entire contents of which are incorporated herein by reference.

### BACKGROUND

### (a) Technical Field

The present disclosure relates to a temperature control system and method for controlling a temperature of a mounting portion upon which an arm of a passenger.

### (b) Background Art

A console box for temporarily storing an item is provided between a driver's seat and a front passenger's seat of a vehicle. At the top of the console box, an armrest is installed to serve as a lid and allow a passenger of the vehicle seated on a seat to comfortably lay down and rest an arm thereon. In addition, in a second or third row, armrests are provided between spaces where passengers are seated. In particular, in a vehicle equipped with independent seats, an armrest is provided on each of the independent seats.

Recently, in order to maintain a comfortable environment in the vehicle, a method allowing the armrest to be used in various ways is desired. In the existing armrest, a pad part made of a cushion material is disposed on a part where an arm of a user is placed, and a heating wire is disposed on a lower surface of the pad part. The user manually sets a temperature of the heating wire, and the temperature of the heating wire rises according to an output value set in stages.

However, when increasing the temperature of the heating wire, a temperature of a contact surface portion of the armrest, e.g., a surface touched by the arm of the passenger, may excessively increase. If the temperature of the heating wire excessively increases, the passenger may feel uncomfortable rather than comfortable. In addition, when the temperature inside the vehicle and the temperature of the armrest surface are low, such as in winter, it takes a lot of time until the passenger feels that the arm in contact with the armrest is warm even when the heating wire is operated.

The above information disclosed in this Background section is only for enhancement of understanding of the background of the present disclosure and therefore it may contain information that does not form the prior art that is already known to a person of ordinary skill in the art.

### SUMMARY OF THE DISCLOSURE

The present disclosure has been made in an effort to solve the above-described problems associated with prior art.

A technical object of the present disclosure is to provide a system and method for controlling a temperature of a mounting portions of a vehicle. The system and method may control a surface temperature of the mounting portion by comparing a temperature of the arm or a hand of a passenger with the surface temperature of the mounting portion so that the passenger feels more comfortable. The surface temperature refers to a temperature of a surface portion of the mounting portion on which an arm of the passenger lay down and rests.

A technical object of the present disclosure is to provide a system and method for controlling a temperature of mounting portion a mounting portion, in particular, controlling a surface temperature of the mounting portion without operating a separate switch.

In one aspect of the present disclosure, a temperature control system for controlling a temperature of a mounting portion of a mounting portion upon which an arm of a passenger rests may include: an mounting portion upon which the arm of the passenger rests, a temperature adjuster provided to the mounting portion to increase a temperature of a surface of the mounting portion, a body temperature sensor provided to the mounting portion to measure a temperature of the arm of the passenger in contact with the mounting portion, a surface temperature sensor configured to measure the temperature of the surface of the mounting portion, and a controller configured to control output of the temperature adjuster based on a difference between the temperature of the surface of the mounting portion measured by the surface temperature sensor and the temperature of the arm of the passenger measured by the body temperature sensor.

In an embodiment, the temperature control system may further include a start signal output device configured to output a signal for starting an operation of the temperature adjuster.

In another embodiment, the start signal output device may recognize a tilt of a tilt portion, which is a part of the mounting portion, and output a signal to the controller.

In still another embodiment, the start signal output device may output a signal indicating a stage of the tilt of the tilt portion to the controller, and the controller may control the output of the temperature adjuster according to the stage of the tilt of the tilt portion.

In yet another embodiment, the start signal output device may include at least one of a proximity sensor configured to recognize a distance between the mounting portion and the arm of the passenger or a pressure sensor configured to measure pressure at which the arm of the passenger presses the mounting portion.

In still yet another embodiment, when the start signal output device is the pressure sensor, the controller may control the output of the temperature adjuster according to a degree of pressure at which the passenger presses a part of the mounting portion on which the pressure sensor is located.

In a further embodiment, when the start signal output device is the proximity sensor, the proximity sensor may transmit a signal indicating that the arm of the passenger is detected within a preset distance to the controller, and the controller may activate the temperature adjuster.

In another further embodiment, when the temperature of the arm of the passenger is greater than or equal to the temperature of the surface of the mounting portion, the controller may maximally control the output of the temperature adjuster until the temperature of the arm of the passenger becomes the same as the temperature of the surface of the mounting portion.

In still another further embodiment, when the temperature of the arm of the passenger becomes the same as the temperature of the surface of the mounting portion, the controller may perform a PI control (Proportional-integral control) on the output of the temperature adjuster until the temperature of the surface of the mounting portion reaches a preset target set temperature.

In yet another further embodiment, when the temperature of the arm of the passenger is less than or equal to the temperature of the surface of the mounting portion, the controller may control the output of the temperature adjuster so that the temperature of the surface of the mounting portion reaches a preset target set temperature.

In still yet another further embodiment, the body temperature sensor may be spatially separated from a portion where the temperature adjuster is disposed by being surrounded by a heat insulating layer.

In another aspect, the present disclosure provides a temperature control method for controlling a temperature of a mounting portion upon which an arm of a passenger rests in a vehicle. In one embodiment, the temperature control method includes: receiving a signal for starting an operation of a temperature adjuster for increasing a temperature of a surface of the mounting portion upon which the arm of the passenger rests, comparing a temperature of the arm of the passenger with the temperature of the surface of the mounting portion to determine output of the temperature adjuster, and increasing a temperature of the temperature adjuster to a preset target set temperature.

In an embodiment, the signal for starting the operation of the temperature adjuster may be a signal received from at least one of a body temperature sensor configured to measure the temperature of the arm of the passenger, a proximity sensor configured to detect that the arm of the passenger approaches the mounting portion, a sensor configured to detect that a stage of a tilt of a part of the mounting portion, or a pressure sensor configured to detect pressure applied to a part of the mounting portion.

In another embodiment, the determining of the output of the temperature adjuster may include maximally controlling the output of the temperature adjuster when the temperature of the arm of the passenger is higher than the temperature of the surface of the mounting portion, or performing PI control on the output of the temperature adjuster until the temperature of the surface of the mounting portion reaches a preset target set temperature when the temperature of the arm of the passenger is less than or equal to the temperature of the surface of the mounting portion.

In still another embodiment, when the temperature of the arm of the passenger is higher than the temperature of the surface of the mounting portion, the output of the temperature adjuster may be maximally controlled until the temperature of the arm of the passenger reaches the temperature of the surface of the mounting portion.

In yet another embodiment, PI control may be performed on the output of the temperature adjuster until the temperature of the surface of the mounting portion reaches a preset target set temperature after the temperature of the arm of the passenger reaches the temperature of the surface of the mounting portion.

In still yet another embodiment, the temperature control method may further include comparing the temperature of the arm of the passenger with the temperature of the surface of the mounting portion again after a predetermined time elapses since the temperature of the surface of the mounting portion has raised to a preset target set temperature.

In a further embodiment, the temperature control method may further include determining whether to manually adjust the temperature of the temperature adjuster after the determining of the output of the temperature adjuster, in which, when the temperature of the temperature adjuster is manually adjusted, the output of the temperature adjuster is determined based on the stage of a signal received from a sensor detecting that a part of the mounting portion is tilted.

Other aspects and embodiments of the present disclosure are discussed below.

The above and other features of the present disclosure are discussed below.

### BRIEF DESCRIPTION OF THE DRAWINGS

The above and other features of the present disclosure are now described in detail with reference to certain exemplary embodiments thereof illustrated in the accompanying drawings which are given hereinbelow by way of illustration only, and thus are not limitative of the present disclosure, and wherein:

FIG. 1 is a diagram illustrating a seat to which a temperature control system of a mounting portion upon which the mounting portions according to an embodiment of the present disclosure is applied;

FIG. 2 is a diagram illustrating a cross-section of the mounting portion according to an embodiment of the present disclosure;

FIG. 3 is a block diagram illustrating the temperature control system of the mounting portion upon which the mounting portions according to an embodiment of the present disclosure;

FIG. 4 is a graph for describing a method of controlling a surface temperature of the mounting portion according to an embodiment of the present disclosure;

FIG. 5 is a graph for describing a method of controlling the surface temperature of the mounting portion according to another embodiment of the present disclosure; and

FIG. 6 is a flowchart illustrating a method of controlling a temperature of the mounting portion upon which the mounting portions according to an embodiment of the present disclosure.

In the figures, reference numbers refer to the same or equivalent parts of the present disclosure throughout the several figures of the drawing.

### DETAILED DESCRIPTION

Advantages and features of the present disclosure, and a method for achieving the advantages and features become apparent with reference to the embodiments described below in detail in conjunction with the accompanying drawings. However, the present disclosure is not limited to the embodiments disclosed below, and may be implemented in various different forms. This embodiment is only provided so that the disclosure of the present disclosure is complete, and to completely inform those of ordinary skill in the art to which the present disclosure pertains of the scope of the present disclosure, and the present disclosure is only defined by the scope of the claims. Like reference numerals refer to like elements throughout the specification.

In addition, a term such as “ . . . part”, “ . . . unit”, “ . . . module”, etc. described in the specification means a unit that processes at least one function or operation, which may be implemented as hardware, software, or a combination of hardware and software.

In addition, in the specification, names of components are divided using first, second, etc. to distinguish the names of the components since the names are the same, and the order is not necessarily limited in the following description. When a component, device, element, or the like of the present disclosure is described as having a purpose or performing an operation, function, or the like, the component, device, or element should be considered herein as being “configured to” meet that purpose or to perform that operation or function.

The detailed description is illustrative of the present disclosure. In addition, the above description shows and describes embodiments of the present disclosure, and the present disclosure may be used in various other combinations, modifications, and environments. That is, changes or modifications are possible within the scope of the concept of the present disclosure disclosed herein, the scope equivalent to the described disclosure, and/or the scope of skill or knowledge in the art. The embodiments describe the best state for implementing the technical idea of the present disclosure, and various changes desired in specific application fields and uses of the present disclosure are possible. Accordingly, the detailed description of the present disclosure is not intended to limit the present disclosure to the disclosed embodiments. In addition, the appended claims should be construed as including other embodiments.

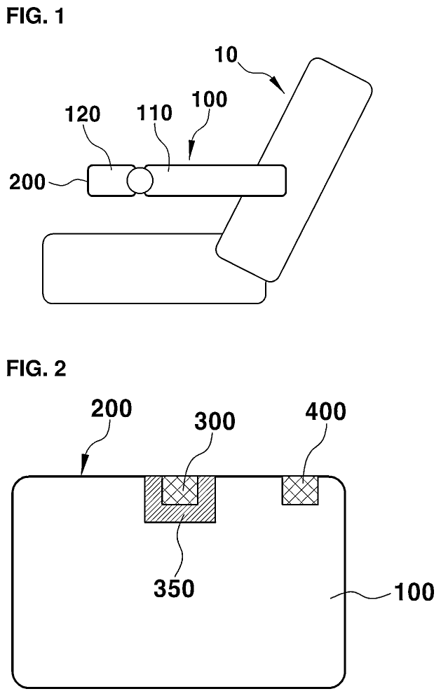

FIG. 1 is a diagram illustrating a seat to which a temperature control system of a mounting portion upon which the mounting portions according to an embodiment of the present disclosure is applied.

Referring to FIG. 1, the temperature control system mounting portion may be applied to a console and an armrest disposed in a vehicle. In one embodiment, the armrest may be mounted on an independent seat, and armrests may be disposed in second and third rows of the vehicle, etc. In an embodiment of the present disclosure, the temperature control system of the mounting portion upon which the arm rests or of the console (collectively “the control system”) may be applied to all configurations capable of supporting or being in contact with an arm of a passenger. In the present embodiment, a description will be given of an example in which the control system of the mounting portion upon which the mounting portions is applied to an armrest mounted on a seat 10.

A mounting portion 100 may be mounted on the seat 10. The mounting portion 100 may be an armrest. The mounting portion 100 may include a main body 110 coupled to the seat 10 and a tiltable tilt portion 120. The tilt portion 120 is a part of the mounting portion 100, and may refer to an end part with respect to a direction toward a front of the seat 10. The tilt portion 120 may be coupled to the main body 110 to be tiltable, and a tilt angle may be adjusted in stages. A temperature adjuster 200 may be disposed on a surface of the mounting portion 100. For example, the temperature adjuster 200 is configured to generate heat, and may include a heating wire, a heating pad, a planar heating element, etc. The temperature adjuster 200 may be in contact with an arm or a hand of the passenger to increase a temperature of the arm or the hand of the passenger.

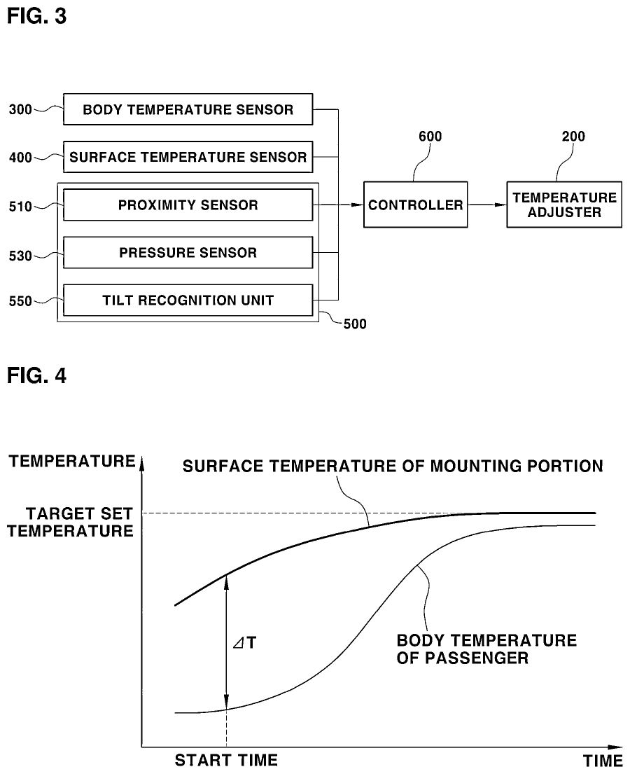

FIG. 2 is a diagram illustrating a cross-section of the mounting portion according to an embodiment of the present disclosure, and FIG. 3 is a block diagram illustrating the temperature control system of the mounting portion upon which the mounting portions according to an embodiment of the present disclosure.

Referring to FIGS. 1, 2 and 3, the temperature control system of the mounting portion may include the temperature adjuster 200, a body temperature sensor 300, a surface temperature sensor 400, a start signal output device 500, and a controller 600. The temperature adjuster 200, the body temperature sensor 300, the surface temperature sensor 400, the start signal output device 500, and the controller 600 may be provided to the mounting portion 100.

The temperature adjuster 200 may be disposed to surround a surface of the mounting portion 100. However, the temperature adjuster 200 may be disposed inside a pad (not illustrated) disposed on the surface of the mounting portion 100. The temperature adjuster 200 may be disposed to surround a remaining space of the mounting portion 100 except for a partial space in which the body temperature sensor 300 is disposed. However, the temperature adjuster 200 may be disposed only on an upper surface or a side surface of the mounting portion 100 in contact with the arm of the passenger.

The body temperature sensor 300 may measure a temperature of the arm of the passenger in contact with the mounting portion 100. Specifically, the body temperature sensor 300 may measure a temperature of the hand of the passenger by coming into contact with the hand of the passenger. A part of the body temperature sensor 300 may be exposed to the outside of the mounting portion 100 to come into contact with the hand or arm of the passenger. The body temperature sensor 300 may be disposed on the tilt portion 120 of the mounting portion 100. The body temperature sensor 300 may be surrounded by a heat insulating layer 350 except for a part exposed to the outside of the mounting portion 100. The heat insulating layer 350 may be provided inside the mounting portion 100. The body temperature sensor 300 may be spatially separated from a portion where the temperature adjuster 200 is disposed by the heat insulating layer 350. That is, the heat insulating layer 350 serves to insulate between the temperature adjuster 200 and the body temperature sensor 300 so that the temperature adjuster 200 does not affect the temperature detected by the body temperature sensor 300. The heat insulating layer 350 enables the body temperature sensor 300 to measure the temperature of the arm or hand of the passenger without being affected by temperature rise of the temperature controller 200. The temperature of the arm or hand of the passenger measured by the body temperature sensor 300 may be transmitted to the controller 600.

The surface temperature sensor 400 may measure a temperature of the temperature adjuster 200 or a pad (not illustrated) disposed on the temperature adjuster 200. In other words, the surface temperature sensor 400 may measure a surface temperature of the mounting portion 100. The surface temperature sensor 400 may measure the surface temperature of the mounting portion 100 by coming into contact with the temperature adjuster 200 or the pad (not illustrated) in contact with the temperature adjuster 200. The surface temperature of the mounting portion 100 measured by the surface temperature sensor 400 may be transmitted to the controller 600.

The start signal output device 500 may refer to an element that outputs a signal for starting an operation of the temperature adjuster 200. For example, the start signal output device 500 may include a proximity sensor 510, a pressure sensor 530, and a tilt recognition unit 550. The signal output by the start signal output device 500 may be transmitted to the controller 600.

In one embodiment, the start signal output device 500 may be the proximity sensor 510. The proximity sensor 510 may recognize a distance between the mounting portion 100 and the arm of the passenger. The proximity sensor 510 may recognize that the arm of the passenger is positioned on the mounting portion 100 before the arm of the passenger comes into contact with the mounting portion 100. The proximity sensor 510 may output a signal to the controller 600 when the arm of the passenger is recognized within a preset distance.

The pressure sensor 530 may measure a pressure at which the arm of the passenger presses the mounting portion 100. Specifically, the passenger may press the tilt portion 120 that is a part of the mounting portion 100, and the pressure sensor 530 may be disposed on the tilt portion 120 to measure the pressure applied by the passenger. When the pressure sensor 530 measures a value greater than or equal to a preset pressure, a signal may be output to the controller 600. In addition, the pressure sensor 530 may transmit a different signal to the controller 600 for each stage of the pressure applied by the passenger. The stage of the pressure may include at least two stages.

For example, the tilt recognition unit 550 may recognize a tilt degree of the tilt portion 120. The tilt portion 120 may be tiltable in a plurality of stages, and the tilt recognition unit 550 may transmit different signals to the controller 600 according to tilting stages of the tilt portion 120.

The controller 600 may start the operation of the temperature adjuster 200 based on signals received from the body temperature sensor 300 and the start signal output device 500. The controller 600 is an element disposed in the mounting portion 100, and may be a type of processor or ECU (Electronic Control Unit).

In one embodiment, the controller 600 may start the operation of the temperature adjuster 200 upon receiving a signal obtained by measuring the temperature of the arm or hand of the passenger from the body temperature sensor 300. Transmitting the signal obtained by measuring the temperature of the arm or hand of the passenger by the body temperature sensor 300 means that the passenger has put an arm on the mounting portion 100. Thus, the controller 600 may start the operation of the temperature adjuster 200. However, when the temperature control system of the mounting portion mounting portion is previously deactivated, the operation of the temperature adjuster 200 may not be started.

For example, upon receiving a signal obtained by measuring that the arm of the passenger is close to the mounting portion 100 by the proximity sensor 510, the controller 600 may start the operation of the temperature adjuster 200. The controller 600 may start the operation of the temperature adjuster 200 in advance before the arm of the passenger comes into contact with the mounting portion 100. In other words, upon receiving a signal from the proximity sensor 510, the controller 600 may activate the temperature adjuster 200 based on a preset output value.

In one embodiment, the controller 600 may start the operation of the temperature adjuster 200 upon receiving a signal for the pressure applied to the tilt portion 120 by the passenger from the pressure sensor 530.

In another embodiment, the controller 600 may start the operation of the temperature adjuster 200 upon receiving a signal recognized by the tilt recognition unit 550.

The controller 600 may control the output of the temperature adjuster 200 based on signals received from the body temperature sensor 300, the surface temperature sensor 400, and the start signal output device 500. The controller 600 may control the output of the temperature adjuster 200 based on a difference between a temperature of the surface of the mounting portion 100 measured by the surface temperature sensor 400 and a temperature of the arm of the passenger measured by the body temperature sensor 300. Specifically, when the temperature of the arm of the passenger is greater than the temperature of the surface of the mounting portion 100, the controller 600 may adjust the output of the temperature adjuster 200 to a maximum value. When the temperature of the arm of the passenger is greater than the temperature of the surface of the mounting portion 100, the passenger feels that the surface of the mounting portion 100 is relatively cold. Accordingly, the controller 600 may maximally control the output of the temperature adjuster 200 so that the temperature of the arm of the passenger and the temperature of the surface of the mounting portion 100 become the same as soon as possible.

The controller 600 may control the output of the temperature adjuster 200 according to the tilt degree of the tilt portion 120. The passenger may manually adjust a stage of the tilt of the tilt portion 120 to manually adjust the temperature of the mounting portion 100, and the controller 600 may control the temperature adjuster 200 according to the stage of the tilt of the tilt portion 120.

The controller 600 may control the output of the temperature adjuster 200 according to a degree of pressure applied to the tilt portion 120 measured by the pressure sensor 530. The passenger may manually adjust the stage of pressure applied to the tilt portion 120 to manually adjust the temperature of the mounting portion 100, and the controller 600 may control the output of the temperature adjuster 200 according to the stage of pressure applied to the tilt portion 120.

The controller 600 may control the output of the temperature adjuster 200 until the surface temperature of the mounting portion 100 reaches a preset target set temperature. The controller 600 controls a current or voltage applied to the temperature adjuster 200 in order to reduce a deviation value between the surface temperature of the mounting portion 100 and the target set temperature through PI control (Proportional-integral control).

According to an embodiment of the present disclosure, the passenger may operate the temperature adjuster 200 without operating a separate switch by placing an arm on the mounting portion 100, applying pressure to the tilt portion 120, or tilting the tilt portion 120.

According to an embodiment of the present disclosure, the controller 600 may control the output of the temperature adjuster 200 based on a relationship between the temperature of the arm or hand of the passenger and the surface temperature of the mounting portion 100. Therefore, since the surface temperature of the mounting portion 100 is controlled based on all of a temperature inside the vehicle, a body temperature of the passenger, and the temperature of the mounting portion 100, the passenger may feel comfortable within a short time after placing an arm on the mounting portion 100.

FIG. 4 is a graph for describing a method of controlling the surface temperature of the mounting portion according to an embodiment of the present disclosure. FIG. 4 is a diagram for describing the case of automatically controlling the surface temperature of the mounting portion.

Referring to FIGS. 3 and 4, when the operation of the temperature adjuster 200 is started, the controller 600 may compare the temperature of the arm or hand of the passenger with the surface temperature of the mounting portion. When the temperature of the arm of the passenger is lower than the surface temperature of the mounting portion, the controller 600 may perform PI control on the output of the temperature adjuster 200 so that the surface temperature of the mounting portion reaches a target set temperature. When the temperature of the arm of the passenger is lower than the surface temperature of the mounting portion, the passenger may not feel cold even after placing an arm on the mounting portion. Therefore, the controller 600 may control the output of the temperature adjuster 200 so that a deviation between the surface temperature of the mounting portion and the target set temperature is continuously reduced rather than abruptly increasing the temperature of the temperature adjuster 200.

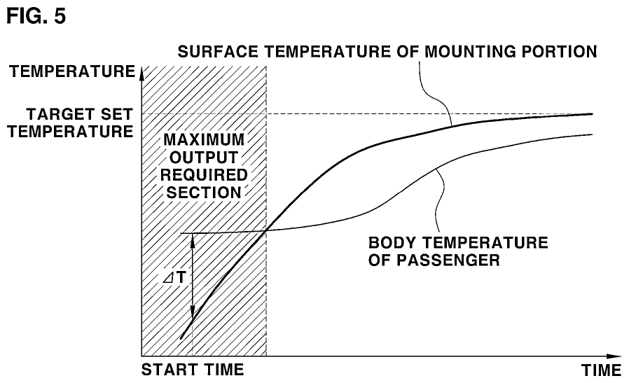

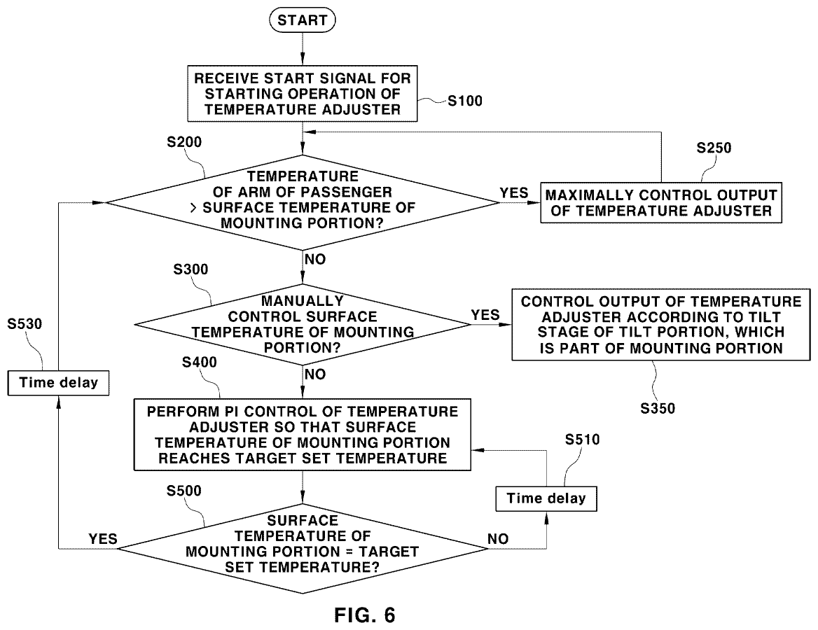

FIG. 5 is a graph for describing a method of controlling the surface temperature of the mounting portion according to another embodiment of the present disclosure. FIG. 5 may be a diagram for describing the case of automatically controlling the surface temperature of the mounting portion.

Referring to FIGS. 3 and 5, when the operation of the temperature adjuster 200 is started, the controller 600 may compare the temperature of the arm or hand of the passenger with the surface temperature of the mounting portion. When the temperature of the arm of the passenger is greater than the surface temperature of the mounting portion, the controller 600 may adjust the output of the temperature adjuster 200 to a maximum value until the temperature of the arm of a passenger becomes the same as the surface temperature of the mounting portion. When the temperature of the arm of the passenger is greater than or equal to the surface temperature of the mounting portion, the passenger may immediately receive a cold feeling in response to placing an arm on the mounting portion. Therefore, the controller 600 may maximally control the output of the temperature adjuster 200 so that the passenger does not feel that the surface of the mounting portion is cold within a short time.

When the temperature of the arm of the passenger becomes the same as the surface temperature of the mounting portion, the controller 600 may perform PI control on the output of the temperature adjuster until the surface temperature of the mounting portion reaches a preset target set temperature. When the temperature of the arm of the passenger becomes the same as the surface temperature of the mounting portion, the passenger may not feel that the surface of the mounting portion is cold. Therefore, the controller 600 may control the output of the temperature adjuster 200 so that the deviation between the surface temperature of the mounting portion and the target set temperature is continuously reduced.

FIG. 6 is a flowchart illustrating a method of controlling the temperature of the mounting portion upon which the mounting portions according to an embodiment of the present disclosure.

Referring to FIG. 6, the controller may receive a signal for starting the operation of the temperature adjuster for increasing the surface temperature of the mounting portion. The controller may operate the temperature adjuster based on a signal received from at least one of the body temperature sensor, the proximity sensor, the pressure sensor, or the tilt recognition unit for outputting the signal for starting the operation of the temperature adjuster (S100).

The controller may control initial output of the temperature adjuster by comparing the temperature of the arm of the passenger measured by the body temperature sensor with the surface temperature of the mounting portion measured by the surface temperature sensor (S200).

When the temperature of the arm of the passenger is higher than the surface temperature of the mounting portion, the controller may maximally control the output of the temperature adjuster. The output of the temperature adjuster may be maximally fixed (i.e., set to a maximum control value) until the temperature of the arm of the passenger becomes the same as the surface temperature of the mounting portion (S250).

When the temperature of the arm of the passenger is equal to or less than the surface temperature of the mounting portion, the controller may determine whether adjustment of the surface temperature of the mounting portion is manually controlled. For example, when the pressure sensor and the tilt recognition unit are applied to the mounting portion, the controller may determine that adjustment of the surface temperature of the mounting portion is manually controlled upon receiving signals output by the pressure sensor and the tilt recognition unit. However, even when the pressure sensor and the tilt recognition unit are applied to the mounting portion, the passenger may previously set the surface temperature of the mounting portion to be automatically adjusted (S300).

When manually controlling the surface temperature of the mounting portion, the controller may control output of the temperature adjuster according to the stage of the tilt of the tilt portion, which is a part of the mounting portion. As another example, the controller may control output of the temperature adjuster according to a degree of pressure applied to the tilt portion measured by the pressure sensor (S350).

When the surface temperature of the mounting portion is not manually controlled, the controller may perform the PI control on the output of the temperature adjuster so that the surface temperature of the mounting portion reaches the target set temperature (S400).

The controller may continuously monitor the surface temperature of the mounting portion. The controller may control the output of the temperature adjuster until the surface temperature of the mounting portion reaches the target set temperature. The controller may monitor the surface temperature of the mounting portion based on a predetermined time interval to adjust the output of the temperature adjuster (S500 and S510).

After a predetermined time elapses after the surface temperature of the mounting portion is raised to the target set temperature, the controller may compare the temperature of the arm of the passenger with the surface temperature of the mounting portion again. When the temperature adjuster is turned off after the surface temperature of the mounting portion reaches the target set temperature, the surface temperature of the mounting portion may become lower than the target set temperature, and the surface temperature of the mounting portion may become lower than the temperature of the arm of the passenger. Therefore, the controller may compare the surface temperature of the mounting portion with the temperature of the arm of the passenger even after the surface temperature of the mounting portion reaches the target set temperature, and may control the output of the temperature adjuster so that the surface temperature of the mounting portion is maintained at the target set temperature (S530).

According to an embodiment of the present disclosure, the passenger may activate the temperature adjuster that increases the temperature of the armrest without operating a separate switch by placing an arm on the armrest, applying pressure to a part of the armrest, or tilting a part of the armrest.

According to an embodiment of the present disclosure, the controller may control output of the temperature adjuster based on a relationship between the temperature of the arm or hand of the passenger and the surface temperature of the mounting portion. Therefore, since the surface temperature of the mounting portion is controlled in consideration of all of the temperature inside the vehicle, the body temperature of the passenger, and the temperature of the mounting portion, the passenger may feel comfortable within a short time after placing an arm on the mounting portion.

Although the embodiments of the present disclosure have been described above with reference to the accompanying drawings, those of ordinary skill in the art to which the present disclosure pertains will understand that the present disclosure may be embodied in other specific forms without changing the technical spirit or essential features thereof. Therefore, it should be understood that the embodiments described above are illustrative in all respects and not restrictive.

What is claimed is:

1. A control system for controlling a temperature of a mounting portion upon which an arm of a passenger rests, the control system comprising:
the mounting portion upon which the arm of the passenger rests;
a temperature adjuster provided to the mounting portion and configured to increase a temperature of a surface of the mounting portion;
a body temperature sensor provided to the mounting portion and configured to measure a temperature of the arm of the passenger in contact with the mounting portion;
a surface temperature sensor configured to measure the temperature of the surface of the mounting portion; and
a controller configured to control an output of the temperature adjuster based on a difference between the temperature of the surface of the mounting portion measured by the surface temperature sensor and the temperature of the arm of the passenger measured by the body temperature sensor.

2. The control system of claim 1, further comprising: a start signal output device configured to output a signal for starting an operation of the temperature adjuster.

3. The control system of claim 2, wherein the start signal output device is configured to recognize a tilt of a tilt portion of the mounting portion and output a signal to the controller.

4. The control system of claim 3, wherein:
the start signal output device is configured to output a signal indicating a stage of the tilt of the tilt portion to the controller; and
the controller is configured to control the output of the temperature adjuster based on the stage of the tilt of the tilt portion.

5. The control system of claim 2, wherein the start signal output device includes at least one of a proximity sensor configured to recognize a distance between the mounting portion and the arm of the passenger or a pressure sensor configured to measure a pressure at which the arm of the passenger presses the mounting portion.

6. The control system of claim 5, wherein, when the start signal output device is the pressure sensor, the controller is configured to control the output of the temperature adjuster based on a degree of pressure at which the passenger presses a part of the mounting portion on which the pressure sensor is located.

7. The control system of claim 5, wherein, when the start signal output device is the proximity sensor, the proximity sensor is configured to transmit a signal indicating that the arm of the passenger is detected within a preset distance to the controller, and the controller is configured to activate the temperature adjuster.

8. The control system of claim 1, wherein, when the temperature of the arm of the passenger is greater than or equal to the temperature of the surface of the mounting portion, the controller is configured to maximally control the output of the temperature adjuster until the temperature of the arm of the passenger becomes the same as the temperature of the surface of the mounting portion.

9. The control system of claim 8, wherein, when the temperature of the arm of the passenger becomes the same as the temperature of the surface of the mounting portion, the controller is configured to perform a Proportional-integral control (PI control) on the output of the temperature adjuster until the temperature of the surface of the mounting portion reaches a preset target set temperature.

10. The control system of claim 1, wherein, when the temperature of the arm of the passenger is less than or equal to the temperature of the surface of the mounting portion, the controller is configured to control the output of the temperature adjuster so that the temperature of the surface of the mounting portion reaches a preset target set temperature.

11. The control system of claim 1, wherein the body temperature sensor is spatially separated from a portion where the temperature adjuster is disposed by being surrounded by a heat insulating layer.

12. A control method for controlling a temperature of a mounting portion of a vehicle upon which an arm of a passenger, the control method comprising:
receiving a signal for starting an operation of a temperature adjuster for increasing a temperature of a surface of the mounting portion upon which the arm of the passenger rests;
comparing a temperature of the arm of the passenger with the temperature of the surface of the mounting portion to determine an output of the temperature adjuster; and
increasing a temperature of the temperature adjuster to a preset target set temperature.

13. The control method of claim 12, wherein the signal for starting the operation of the temperature adjuster is a signal received from at least one of a body temperature sensor configured to measure the temperature of the arm of the passenger, a proximity sensor configured to detect that the arm of the passenger approaches the mounting portion, a sensor configured to detect a stage of a tilt of a part of the mounting portion, or a pressure sensor configured to detect a pressure applied to a part of the mounting portion.

14. The control method of claim 12, wherein determining the output of the temperature adjuster includes:
maximally controlling the output of the temperature adjuster when the temperature of the arm of the passenger is higher than the temperature of the surface of the mounting portion; or
performing a Proportional-integral control (PI control) on the output of the temperature adjuster until the temperature of the surface of the mounting portion reaches a preset target set temperature when the temperature of the arm of the passenger is less than or equal to the temperature of the surface of the mounting portion.

15. The control method of claim 14, wherein, when the temperature of the arm of the passenger is higher than the temperature of the surface of the mounting portion, the output of the temperature adjuster is maximally controlled until the temperature of the arm of the passenger reaches the temperature of the surface of the mounting portion.

16. The control method of claim 15, wherein the PI control is performed on the output of the temperature adjuster until the temperature of the surface of the mounting portion reaches a preset target set temperature after the temperature of the arm of the passenger reaches the temperature of the surface of the mounting portion.

17. The control method of claim 12, further comprising: comparing the temperature of the arm of the passenger with the temperature of the surface of the mounting portion again after a predetermined time elapses since the temperature of the surface of the mounting portion has risen to a preset target set temperature.

18. The control method of claim 12, further comprising: determining whether to manually adjust the temperature of the temperature adjuster after the determining of the output of the temperature adjuster,
wherein, when the temperature of the temperature adjuster is manually adjusted, the output of the temperature adjuster is determined based on a stage of a signal received from a sensor detecting that a part of the mounting portion is tilted.
